(19) United States
(12) Patent Application Publication
(10) Pub. No.: US 2004/0230398 A1
(43) Pub. Date: Nov. 18, 2004

(54) Sleep analyzer and program product for giving sleep analysis function to computer

(75) Inventors: Shima Okada, Osaka-City (JP); Yshihisa Fujiwara, Uji-City (JP); Hidetaka Sakai, Katano-City (JP); Takeshi Minamiura, Osaka-City (JP)

Correspondence Address: McDERMOTT, WILL & EMERY, 600 13th Street, N.W., Washington, DC, 20005-3096, US

(73) Assignee: SANYO ELECTRIC CO., LTD.

(21) Appl. No.: 10/844,324

(22) Filed: May 13, 2004

(30) Foreign Application Priority Data
May 15, 2003 (JP) 2003-137845 (P)

(51) Int. Cl. G06F 11/30

(52) U.S. Cl. 702/182

(57) ABSTRACT

The present invention provides a new sleep analysis technique with which sleep analysis with relatively high reliability can be simply and speedily performed by using sleeping depth data. An appearance ratio conversion processing portion reads sleeping depth data (qualitative variable) stored in a RAM to calculate a movement appearance ratio n-M.A.R. (quantitative variable) meeting a relation of sleeping depth=2 (deep sleep: SWS). Then, an evaluation result calculation processing portion reads the calculated movement appearance ratio data (quantitative variable) from the RAM, and processes the calculated movement appearance ratio data in accordance with an evaluation rule in an evaluation rule storage portion to calculate an evaluation score for the evaluation factor concerned. When the evaluation factor is “rapidity of falling asleep” for example, a time period from a point when a person goes to bed to a point when the movement appearance ratio n-M.A.R. of the SWS rises is detected from the movement appearance ratio n-M.A.R. of the SWS. Then, an evaluation score corresponding to a length of a time period of the rising is acquired from a corresponding score table. According to the present invention, the sleeping depth data expressed as the qualitative variable is converted into the data related to the appearance ratio of the sleeping depth and expressed as the quantitative variable, and the evaluation factors are analyzed and evaluated using the data after the conversion. Thus, various evaluation factors such as “rhythm of sleep”, “mental recovery”, “physical recovery” and “rapidity of falling asleep” can be quantitatively evaluated. As a result, simplification for the processing can be realized and at the same time, highly reliable sleep analysis results can be provided.

### BACKGROUND OF THE INVENTION

1. Field of the Invention

The present invention relates to a sleep analyzer for analyzing a sleep state based on sleep stage data of a subject, and a program product for executing a sleep analysis function.

2. Description of the Related Art

Heretofore, analysis of sleep is generally carried out, for example, by referring to the graph shown in FIG. 10 representing depth of sleep (hereinafter also referred to as “sleep stage”).

The graph shown in the figure is obtained by expressing a sleep state of a subject in one day in the form of data. In the figure, an axis of abscissa represents elapsed time after the subject retires to bed, and an axis of ordinate represents sleep stage. As for the sleep stage, for example, as shown in the figure, in addition to a wakeful state (W) and a Rapid Eye Movement (REM) state (R), four stages of sleeping depths corresponding to the sleeping depths are set. Note that the data in the figure is normally calculated by measuring EEG (electroencephalogram), a heart rate, respiration, a skin temperature and the like with a measurement apparatus being worn on a subject to process the measured data by utilizing an existing polysomnogram method.

However, since the sleep stage in the graph produced based on the conventional technique is expressed by qualitative variables, a sleep state of the subject can not be properly analyzed and evaluated unless such analysis and evaluation are carried out by a specialist such as a doctor.

However, in recent years, the number of persons having trouble with sleep has rapidly increased with the progress of aging and increased stress in the society. Under such a situation, it is desirable to realize an apparatus/system which is capable of carrying out simple and speedy sleep analysis with relatively high reliability without depending on a specialist such as a doctor. However, the above-mentioned graph is expressed by qualitative variables. Thus, if a computer or sleep analyzer is made to carry out the sleep analysis using the qualitative variables, a database having enormous knowledge is required depending on an analysis technique utilized by a doctor or the like in order to analyze and evaluate the qualitative variables, and so is an operation processing program using the same. Hence, simple and speedy analysis and evaluation of sleep quality can not be realized. In addition, it is very difficult to quantitatively analyze and evaluate various evaluation factors such as “rhythm of sleep”, “mental recovery”, “physical recovery”, “refreshed of awakening” and “rapidity of falling asleep” based on the graph expressed using the qualitative variables.

In the light of the foregoing, the present invention has been made in order to solve the above-mentioned problems, and it is, therefore, an object of the present invention to provide a new sleep analysis technique with which sleep analysis can be carried out simply and speedily with relatively high reliability by using the above-mentioned graph data expressing sleep stage.

### SUMMARY OF THE INVENTION

According to the present invention, data (quantitative variable) related to an appearance ratio of a sleep stage is generated from data (qualitative variable) related to the sleeping depth and plotted on a time scale, and analysis and evaluation for “rhythm of sleep”, “mental recovery”, “physical recovery”, “rapidity of falling asleep” and the like are carried out based on the data related to the appearance ratio. That is to say, according to the present invention, the data on the sleeping depth data expressed as the qualitative variable is converted into the appearance ratio of the sleep stage expressed as the quantitative variable to allow various evaluation factors such as “rhythm of sleep”, “mental recovery”, “physical recovery”, and “rapidity of falling asleep” to be quantitatively evaluated so that highly reliable sleep analysis is realized by simplified processing.

According to a first aspect of the present invention, there is provided a sleep analyzer including: data generation means for generating data related to an appearance ratio of a sleep stage from data related to a depth of sleep and plotted on a time scale; storage means for storing therein an evaluation rule corresponding to an evaluation factor; and evaluation result calculation means for calculating results of evaluation for the evaluation factor by processing the data related to the appearance ratio of the sleep stage and generated by the data generation means in accordance with the evaluation rule stored in the storage means.

In the first aspect of the present invention, a configuration may be adopted in which: the data generation means calculates an appearance ratio of a sleep stage equal to or higher than a predetermined level for each predetermined time unit; the storage means stores therein a rule in accordance with which rhythm of sleep is evaluated based on cycle time of a fluctuation cycle of the appearance ratio on the time scale; and the evaluation result calculation means calculates results of evaluation for rhythm of sleep during the sleep by detecting the cycle time of the fluctuation cycle from the appearance ratio calculated for each predetermined time unit by the data generation means and evaluating the cycle time in accordance with the evaluation rule stored in the storage means.

Further, in the first aspect of the present invention, a configuration may be adopted in which: the data generation means calculates an appearance ratio of a sleep stage equal to or higher than a predetermined level; the storage means stores therein a rule in accordance with which mental recovery during sleep is evaluated based on the appearance ratio; and the evaluation result calculation means calculates results of evaluation for mental recovery during the sleep by evaluating the appearance ratio calculated by the data generation means in accordance with the evaluation rule stored in the storage means.

Further, in the first aspect of the present invention, a configuration may be adopted in which: the data generation means calculates an appearance ratio of a sleep stage at a REM level; the storage means stores therein a rule in accordance with which physical recovery during sleep is evaluated based on the appearance ratio; and the evaluation result calculation means calculates results of evaluation for physical recovery during the sleep by evaluating the appearance ratio calculated by the data generation means in accordance with the evaluation rule stored in the storage means.

Further, in the first aspect of the present invention, a configuration may be adopted in which: the data generation means calculates an appearance ratio of a sleep stage equal to or higher than a predetermined level for each predetermined time unit; the storage means stores a rule in accordance with which rapidity of falling asleep is evaluated based on a time period required until the appearance ratio as plotted on the time scale rises for a first time; and the evaluation result calculation means detects the time period required until the appearance ratio rises for the first time on the time scale from the appearance ratio calculated for each predetermined time unit by the data generation means, and evaluates the time period in accordance with the evaluation rule stored in the storage means to calculate results of evaluation for the rapidity of falling asleep with respect to the sleep.

Further, in the first aspect of the present invention, a configuration may be adopted in which: the data generation means calculates an appearance ratio of a sleep stage equal to or higher than a predetermined level for each predetermined time unit; the storage means stores a rule in accordance with which a refreshed of wakening is evaluated based on a gradient at which the appearance ratio as plotted on the time scale drops for a last time; and the evaluation result calculation means detects a gradient at which the appearance ratio drops for the last time on the time scale from the appearance ratio calculated for each predetermined time unit by the data generation means, and evaluates the gradient in accordance with the evaluation rule stored in the storage means to calculate results of evaluation for the refreshed of wakening with respect to the sleep.

Further, according to a second aspect of the present invention, there is provided a sleep analyzer, wherein the sleep analyzer obtains data related to an appearance ratio of a sleep stage from data related to a depth of sleep and plotted on a time scale and carries out sleep analysis based on the obtained data related to the appearance ratio.

Further, according to a third aspect of the present invention, there is provided a program product for giving a sleep analysis function to a computer, including: a data generation step of generating data related to an appearance ratio of a sleep stage from data related to a depth of sleep and plotted on a time scale; a database prescribing an evaluation rule corresponding to an evaluation factor; and an evaluation result calculation step of calculating results of evaluation for the evaluation factor by processing the data related to the appearance ratio of the sleep stage and generated in the data generation step in accordance with the evaluation rule.

In the third aspect of the present invention, a configuration may be adopted in which the data generation step includes calculating an appearance ratio of a sleep stage equal to or higher than a predetermined level for each predetermined time unit; the database prescribes a rule in accordance with which rhythm of sleep is evaluated based on cycle time of a fluctuation cycle of the appearance ratio on the time scale; and the evaluation result calculation step includes detecting the cycle time of the fluctuation cycle from the appearance ratio calculated for each predetermined time unit in the data generation step and evaluating the cycle time in accordance with the evaluation rule prescribed in the database to calculate results of evaluation for rhythm of sleep with respect to the sleep.

Further, in the third aspect of the present invention, a configuration may be adopted in which: the data generation step includes calculating an appearance ratio of a sleep stage equal to or higher than a predetermined level; the database prescribes a rule in accordance with which mental recovery during sleep is evaluated based on the appearance ratio; and the evaluation result calculation step includes calculating results of evaluation for mental recovery during the sleep by evaluating the appearance ratio calculated by the data generation means in accordance with the evaluation rule prescribed in the database.

Further, in the third aspect of the present invention, a configuration may be adopted in which: the data generation step includes calculating an appearance ratio of a sleep stage at a REM level; the database prescribes a rule in accordance with which physical recovery during sleep is evaluated based on the appearance ratio; and the evaluation result calculation step includes calculating results of evaluation for physical recovery during the sleep by evaluating the appearance ratio calculated in the data generation step in accordance with the evaluation rule prescribed in the database.

Further, in the third aspect of the present invention, a configuration may be adopted in which: the data generation step includes calculating an appearance ratio of a sleep stage equal to or higher than a predetermined level for each predetermined time unit; the database prescribes a rule in accordance with which rapidity of falling asleep is evaluated based on a time period required until the appearance ratio as plotted on the time scale rises for a first time; and the evaluation result calculation step includes detecting the time period required until the appearance ratio rises for the first time on the time scale from the appearance ratio calculated for each predetermined time unit in the data generation step, and evaluating the time period in accordance with the evaluation rule prescribed in the database to calculate results of evaluation for the rapidity of falling asleep with respect to the sleep.

Further, in the third aspect of the present invention, a configuration may be adopted in which: the data generation step includes calculating an appearance ratio of a sleep stage equal to or higher than a predetermined level for each predetermined time unit; the database prescribes a rule in accordance with which a refreshed of awakening is evaluated based on a gradient at which the appearance ratio as plotted on the time scale drops for a last time; and the evaluation result calculation step includes detecting the gradient at which the appearance ratio drops for the last time on the time scale from the appearance ratio calculated for each predetermined time unit in the data generation step, and evaluating the gradient in accordance with the evaluation rule prescribed in the database to calculate results of evaluation for the refreshed of awakening with respect to the sleep.

These and other objects as well as novel features of the present invention will become more apparent upon reading the following description of an embodiment of the present invention taken in conjunction with the accompanying drawings. However, the following embodiment is merely an example of the present invention, and is not intended to restrict the scope of the present invention.

### BRIEF DESCRIPTION OF THE DRAWINGS

In the accompanying drawings:

FIG. 1 shows a view of a configuration of a sleep analysis system according to an embodiment of the present invention;

FIG. 2 shows a block diagram of a configuration of a sleep analyzer according to the embodiment of the present invention;

FIG. 3 shows a functional block diagram of the sleep analyzer according to the embodiment of the present invention;

FIG. 4 shows a flow chart explaining an operation of the sleep analyzer according to the embodiment of the present invention;

FIG. 5 shows an example of conversion from data of sleeping depths to data of an SWS (Slow Wave Sleep) appearance ratio;

FIG. 6 shows an example of conversion from data of sleeping depths to data of an SWS (Slow Wave Sleep) appearance ratio;

FIG. 7 shows an example of conversion from data of sleeping depths to data of an REM (Rapid Eye Movement) appearance ratio;

FIG. 8 shows an example of conversion from data of sleeping depths to data of an REM (Rapid Eye Movement) appearance ratio;

FIGS. 9A to 9C show examples of display of sleep types according to the embodiment of the present invention; and

FIG. 10 shows an example of data of sleeping depths.

### DETAILED DESCRIPTION OF THE PREFERRED EMBODIMENTS

Embodiments of the present invention will hereinafter be described with reference to the accompanying drawings.

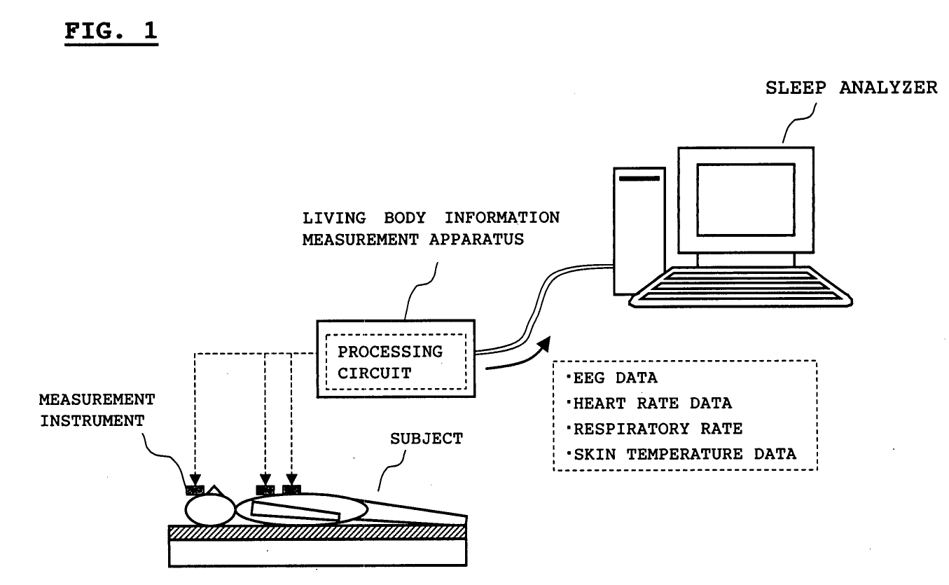

First of all, FIG. 1 shows a configuration of a sleep analysis system according to an embodiment of the present invention. As shown in the figure, the sleep analysis system includes a living body information measurement apparatus for measuring living body information (a heart rate, a respiratory rate, body movement and the like), and a sleep analyzer for processing data (measured values) supplied from the living body information measurement apparatus to carry out sleep analysis.

Here, the living body information measurement apparatus, for example, includes measurement instruments (a pad and the like) to be worn on a subject, and a processing circuit for processing signals from the measurement instruments to measure living body information (EEG, ECG (electrocardiogram) rate, a respiration, a skin temperature and the like) of the subject concerned. In addition, the sleep analyzer, for example, is configured by installing software (a program/database) for sleep analysis in a general purpose personal computer or the like. In addition to this configuration, the sleep analyzer may also be configured as an apparatus in which software (a program/database) for making a CPU carry out a necessary function is previously mounted to a self-contained read only memory (ROM) or the like.

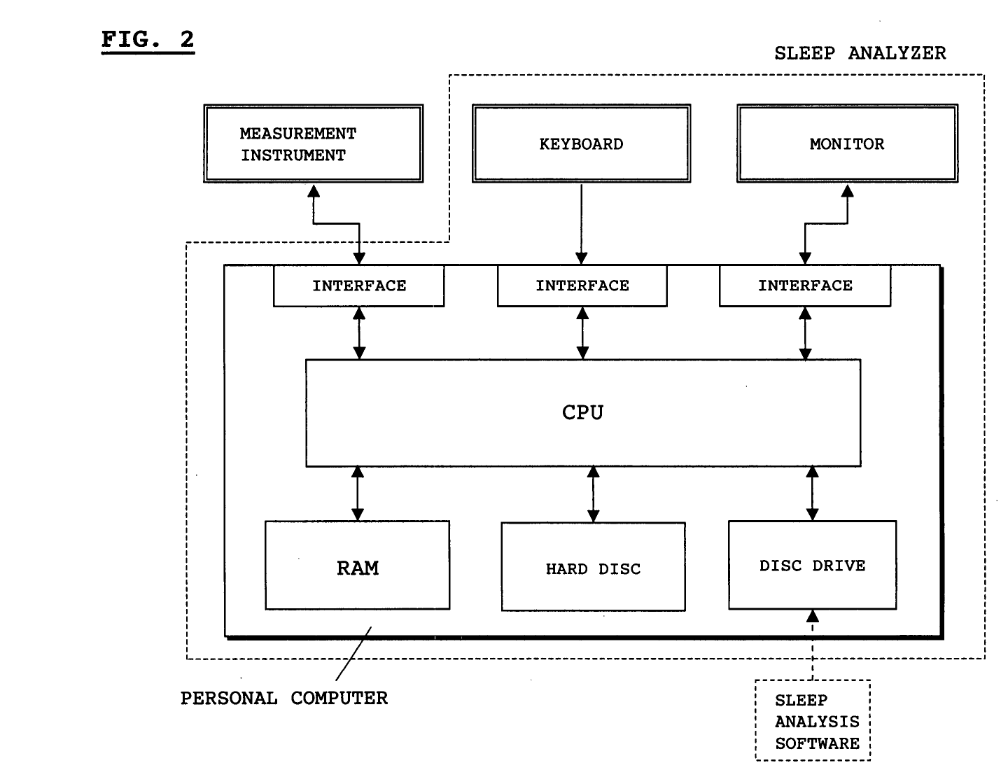

FIG. 2 shows an example of a configuration in a case where the software for sleep analysis is installed in the general-purpose personal computer. After a disc (CD-ROM or the like) retaining the software for sleep analysis is inserted into a disc drive, the software is read out from the disc to be stored in a hard disc. When the software is activated, the corresponding program and database are transferred from the hard disc to a random access memory (RAM). Thus, a function corresponding to the program concerned is executed by a control processing unit (CPU).

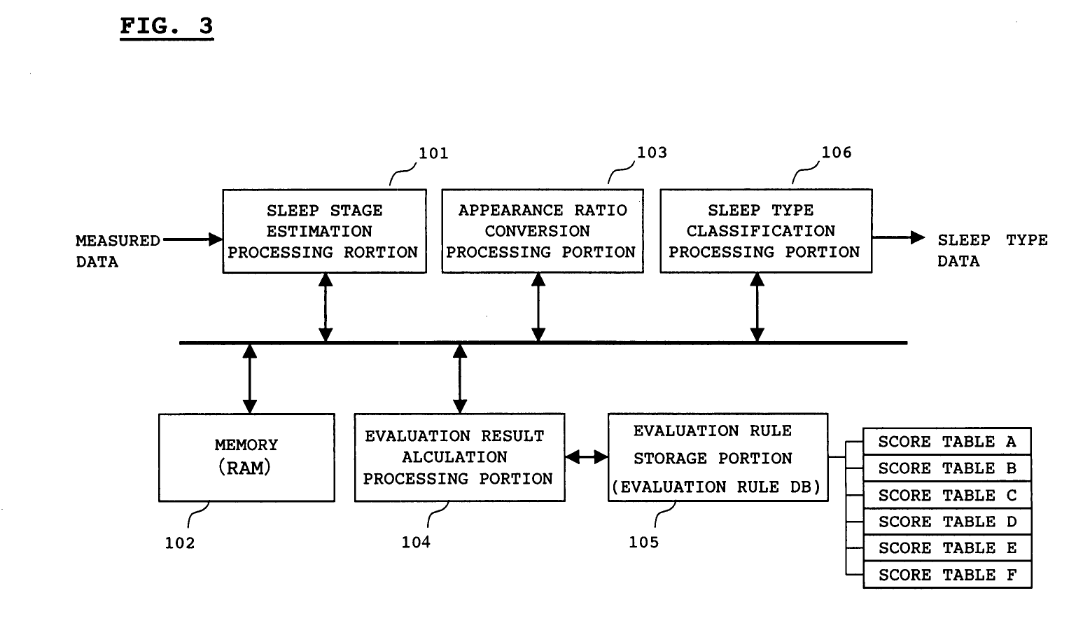

FIG. 3 shows functions executed by the sleep analyzer in the form of functional blocks. As shown in the figure, the sleep analyzer includes functional blocks having a sleeping depth estimation processing portion 101, a RAM 102, an appearance ratio conversion processing portion 103, an evaluation result calculation processing portion 104, an evaluation rule storage portion 105, and a sleep type classification processing portion 106. Note that for the RAM 102, an area used as a work RAM of the RAM shown in FIG. 2 during the sleep analysis is illustrated for the sake of convenience.

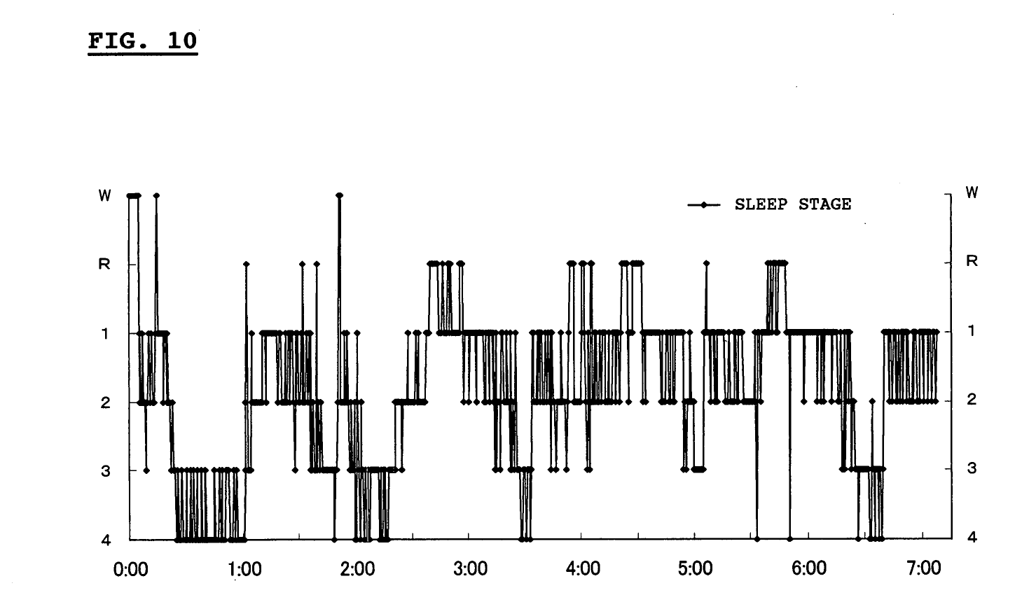

The sleep stage estimation processing portion 101 operates and processes data which was measured with the living body information measurement apparatus and which indicates a sleep state of a subject in one day through a processing process complying with the above-mentioned polygraph method for example to calculate sleep stage data as shown in FIG. 10. The RAM 102 temporarily stores therein processing results obtained from the respective portions.

The appearance ratio conversion processing portion 103 calculates a movement appearance ratio n-M.A.R. (s, t) for each lapse of n minutes from the sleeping depth data calculated in the sleeping depth estimation processing portion 101. Here, the movement appearance ratio n-M.A.R.(s, t) is calculated in accordance with Equation 1.

$$n - M . A . R . ( s , t ) = \frac{{\sum }_{i = t - n / T}^{t} SS ( s , i )}{n} \times 100$$

$$SS ( s , t ) = \{ \begin{matrix}T , & if Stage ( t ) = s . \\ 0 , & otherwise . \end{matrix} \\ t \text{:} epoch number \\ Stage ( t ) \text{:} sleep stage at t .$$

Here, epoch numbers mean division numbers which are obtained by dividing the n minutes by T minutes. Consequently, when a sleep stage (t) at timing of an epoch number t is equal to a set value s, SS(s, t)=T is obtained, while when the sleep stage (t) takes a value other than the set value s, SS(s, t)=0 is obtained. With Equation 1, a plurality of SSs(s, t) in all the epoch numbers are added, and from a ratio of the addition value to the period of the n minutes, the measurement appearance ratio n-M.A.R. (s, t) in the n minutes is calculated.

Note that a concrete calculation example of such a movement appearance ratio n-M.A.R. (s, t) will be described in explanation of an operation of the sleep analyzer later.

The evaluation result calculation processing portion 104 processes the movement appearance ratio data calculated in the appearance ratio conversion processing portion 103 in accordance with evaluation rules retained in the evaluation rule storage portion 105 to calculate results of evaluation for the evaluation factors such as “rhythm of sleep”, “mental recovery”, “physical recovery”, “rapidity of falling asleep” and “refreshed of awakening”. In addition, the evaluation result calculation processing portion 104 processes the sleeping depth data calculated in the sleeping depth estimation processing portion 101 in accordance with the evaluation rules retained in the evaluation rule storage portion 105 to calculate results of evaluation for an evaluation factor as “waking after sleep onset”.

The evaluation rule storage portion 105 holds therein the evaluation rules (database) for the evaluation factors such as “rhythm of sleep”, “mental recovery”, “physical recovery”, “rapidity of falling asleep”, “refreshed of awakening” and “waking after sleep onset”. Also, the evaluation rule storage portion 105 retains therein score tables A to F to which reference is to be made in the evaluation rules. Note that concrete examples of the evaluation rules and the score tables will be exemplified in an explanation of the operation of the sleep analyzer later.

The sleep type analysis processing portion 106 generates information related to a sleep type of the subject concerned from the data calculated in the evaluation result calculation processing portion 104 to output the resultant information. That is to say, the results of evaluation for the evaluation factors such as “rhythm of sleep”, “mental recovery”, “physical recovery”, “rapidity of falling asleep”, “refreshed of awakening” and “waking after sleep onset” are corrected and normalized based on personal information such as sex, age, height, and weight, and environmental information such as season, time at which a person goes to bed, and time at which a person gets out of bed to output information related to ranks of the evaluation factors.

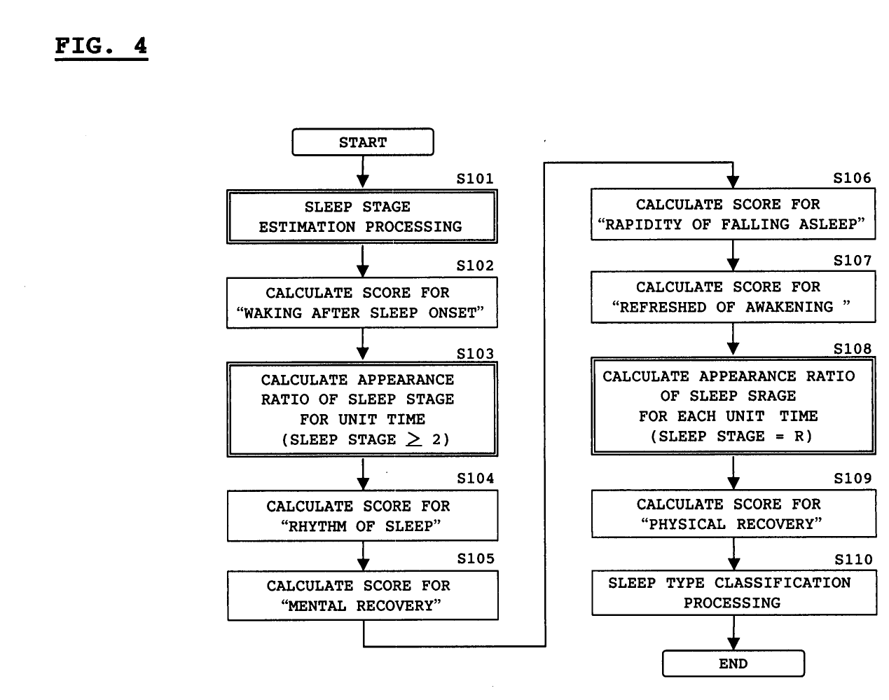

Next, an operation of the sleep analyzer will hereinafter be described with reference to FIG. 4.

Upon reception of measured data (for one day) of a subject, the sleeping depth estimation processing portion 101 generates sleeping depth data from such measured data to store the sleeping depth data in the RAM 102 (S101). Thereafter, the evaluation result calculation processing portion 104 reads out the stored sleeping depth data from the RAM 102 to process the sleeping depth data thus read out in accordance with the evaluation rule for “waking after sleep onset” stored in the evaluation rule storage portion 105. Then, the evaluation result calculation processing portion 104 calculates an evaluation score for the evaluation factor concerned to store the evaluation score in the RAM 102 (S102).

Here, the evaluation rule for “waking after sleep onset” is regulated so that when the number of times of the sleeping depth=W (wakening) during the period of the entire measurement (i.e., the number of times of wakening for one night) is zero, the score is 100, and as the number of times of the sleep stage=W (wakening) increases, the score decreases. Note that it is determined that when wakening occurs six times or more a night, this situation may be judged as an insomnia case. Thus, the regulation may be made such that the score when the number of times of the sleep stage=W (wakening) is equal to six is zero.

Moreover, a period of time of the sleep may be divided into two parts, i.e., the first half and the second half, or may be divided more finely. In this case, the score may be weighted depending on in which of time zones the wakening occurs. For example, a person who tends to awake during sleep shows such a tendency that the number of times of wakening increases as time elapses. Thus, it is possible to judge that the waking after sleep onset occurring in the first half of sleep is relatively serious in the degree of insomnia, while the waking after sleep onset occurring in the second half of the sleep is relatively mild in the degree of insomnia. Therefore, when the number of times of wakening is the same, the score in the first half may be made smaller and the score may increase toward the second half.

In the above-mentioned Step S102, the evaluation result calculation processing portion 104 firstly detects the number of times of the sleep stage=W (wakening) from the sleep stage data. For example, in the example shown in FIG. 10, the number of times of sleep stage=W (wakening) is two. Then, the evaluation result calculation processing portion 104 processes the detection results thereof in accordance with the above-mentioned evaluation rule to calculate an evaluation score for “waking after sleep onset” to store the evaluation score in the RAM 102.

Next, the appearance ratio conversion processing portion 103 reads out the sleep stage data stored in the RAM 102 to calculate a movement appearance ratio n-M.A.R. meeting a relationship of the set value S of the sleeping depth=2 (deep sleep: SWS) in accordance with Equation 1 to store the resultant movement appearance ratio n-M.A.R. in the RAM 102 (S103).

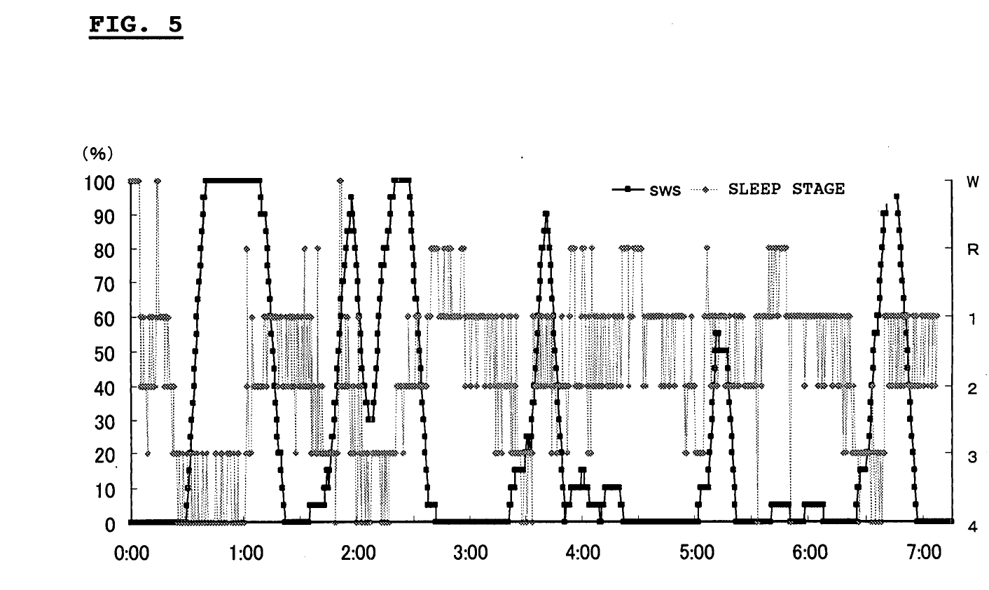

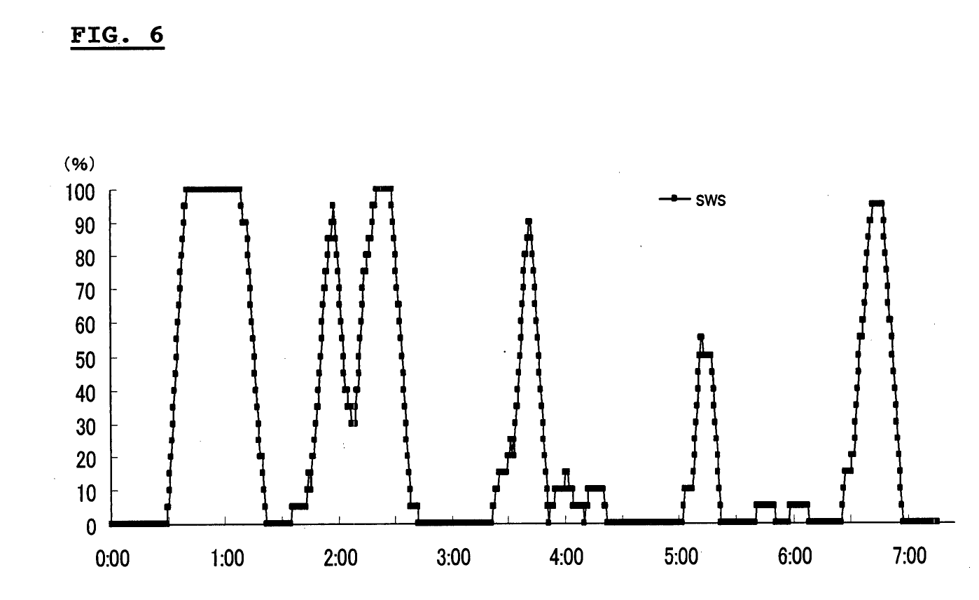

FIGS. 5 and 6 are graphs showing calculation examples when n=10 minutes, and T=0.5 minutes. Here, FIG. 5 shows a graph when the sleeping depth data and the movement appearance ratio data are plotted on a time scale and FIG. 6 shows a graph when only the movement appearance ratio data is plotted on the time scale.

Thereafter, the evaluation result calculation processing portion 104 reads out the movement appearance ratio data of the SWS stored in the RAM 102. Then, the evaluation result calculation processing portion 104 processes the movement appearance ratio data of the SWS in accordance with the evaluation rule for “rhythm of sleep” stored in the evaluation value storage portion 105 to calculate an evaluation score for the evaluation factor concerned to store the evaluation score in the RAM 102 (S104).

Here, the evaluation value for “rhythm of sleep” is regulated as follows.

(1) Setting of Cycle

A period of time from the time at which the movement appearance ratio n-M.A.R of SWS rises from 0% to the time at which, after exceeding a predetermined threshold level S1 (e.g., 40%) and then dropping down to 0% again, the movement appearance ratio of the SWS rises next time is set as one cycle.

(2) Score for each Cycle

The score is set as 100 when a period of time of one cycle falls within a time range R1, and the score decreases as the period of time of one cycle deviates from this time range R1. For example, it is regarded that an appropriate period of time from start of non-REM sleep to end of REM sleep following the non-REM sleep is in a range of 90 minutes to 100 minutes (refer to “SCIENCE OF SLEEP” issued by ASAKURA PUBLISHING CO. LTD., page 34, 1984, for example). Thus, a relationship of 90 minutes=R1=100 minutes is adopted. In addition, the time range of 30 minutes before and after the time range R1 is divided into sections. At this time, the score of each section decreases with increasing deviation from R1 (when the section is beyond the range of 30 minutes before and after the time range R1, the score is zero).

(3) Score for “Sleep Rhythm”

The total of the scores in the respective cycles is set as the score for “rhythm of sleep”.

In the above-mentioned Step S104, the evaluation result calculation processing portion 104 firstly detects the above-mentioned cycles and cycle time from the movement appearance ratio n-M.A.R. of the SWS. For example, in the example shown in FIG. 6, there are five cycles. Then, the evaluation result calculation processing portion 104 processes the detection results in accordance with the corresponding one of the above-mentioned evaluation rules to calculate an evaluation score for “rhythm of sleep” to store the evaluation score in the RAM 102.

Next, the evaluation result calculation processing portion 104 processes the movement appearance ratio data of the SWS in accordance with the evaluation rule for “mental recovery” stored in the evaluation rule storage portion 105 to calculate an evaluation score for the evaluation factor concerned to store the evaluation score in the RAM 102 (S105).

Here, the evaluation rule for “mental recovery” is regulated as follows since the non-REM sleep is regarded as the sleep of the brain (refer to “SLEEPICS HANDBOOK” issued by ASAKURA PUBLISHING CO. LTD., page 32, 1994, for example).

(1) Setting of Cycle

A period of time from the time at which the movement appearance ratio n-M.A.R of SWS rises from 0% to the time at which, after exceeding a predetermined threshold level S1 (e.g., 40%) and then dropping down to 0% again, the movement appearance ratio of the SWS rises next time is set as one cycle.

(2) Score for each Cycle

The score is set as 100 when a peak of the movement appearance ratio n-M.A.R. of the SWS within a period of time of one cycle reaches 100%. The score decreases as the peak concerned decreases from 100%. Note that the peak of the movement appearance ratio n-M.A.R. is more difficult to reach 100% as time elapses during sleep. Thus, the period of sleep may be divided into two parts, i.e., the first half and the second half, or may be divided more finely. In this case, a peak value threshold may be gradually decreased from 100% toward the end of the sleep period.

(3) Score for “Mental Recovery”

The total of the scores in the respective cycles is set as a score for “mental recovery”.

In the above-mentioned Step S105, the evaluation result calculation processing portion 104 firstly detects the cycles and the peaks of the movement appearance ratio n-M.A.R. in the respective cycles from the movement appearance ratio n-M.A.R. of the SWS. For example, in the example shown in FIG. 6, there are five cycles, and the peaks of the first, second, and fifth cycles reach 100%. Then, the evaluation result calculation processing portion 104 processes the detection results in accordance with the corresponding one of the above-mentioned evaluation rules to calculate an evaluation score for “mental recovery” to store the evaluation score in the RAM 100.

Next, the evaluation result calculation processing portion 104 processes the movement appearance ratio data of the SWS in accordance with the evaluation rule for “rapidity of falling asleep” stored in the evaluation rule storage portion 105 to calculate an evaluation score for the evaluation factor concerned to store the evaluation score in the RAM 102 (S106).

Here, “rapidity of falling asleep” can be evaluated based on a period of time from a time point when a person goes to bed to a time point when the person falls asleep. Thus, the evaluation rule for “rapidity of falling asleep” is regulated by a period of time from a time point when a person goes to bed to a time point when the movement appearance ratio n-M.A.R. of the SWS rises. For example, the score is set as 100 when a period of time from a time point when a person goes to bed to a time point when the movement appearance ratio n-M.A.R. of the SWS rises is 20 minutes or less. Then, the period of time from 20 minutes to 60 minutes is divided into four ten-minute sections, and the scores are set in the respective divisions such that the score decreases as time elapses from 20 minutes (the score when the division exceeds 60 minutes is set as zero).

In the above-mentioned Step S106, the evaluation result calculation processing portion 104 firstly detects a period of time from a time point when a person goes to bed to a time point when the movement appearance ratio n-M.A.R. of the SWS rises from the movement appearance ratio n-M.A.R. of the SWS. Then, the evaluation result calculation processing portion 104 processes the detection results in accordance with the corresponding one of the evaluation rules to calculate an evaluation score for “rapidity of falling asleep” to store the evaluation score in the RAM 102.

Next, the evaluation result calculation processing portion 104 processes the movement appearance ratio data of the SWS in accordance with the evaluation rule for “refreshed of awakening” stored in the evaluation rule storage portion 105 to calculate an evaluation score for the evaluation factor concerned to store the evaluation score in the RAM 102 (S107).

Here, “refreshed of awakening” can be evaluated based on a speed of wakening. Thus, the evaluation rule for “refreshed of awakening” is regulated by a gradient at which the movement appearance ratio n-M.A.R. of the SWS drops for the last time. For example, the value calculated by subtracting the value of the movement appearance ratio n-M.A.R of the SWS for the time point just before the n-M.A.R is getting to 0% while the n-M.A.R of the SWS drops for the last time from 100% is set as the score of “refreshed of awakening”.

In the above-mentioned Step S107, the evaluation result calculation processing portion 104 firstly detects a gradient at which the movement appearance ratio n-M.A.R. of the SWS drops for the last time. Then, the evaluation result calculation processing portion 104 processes the detection results in accordance with the corresponding one of the evaluation rules to calculate an evaluation score for “refreshed of awakening” to store the evaluation score in the RAM 102.

After the evaluation processing using the movement appearance ratio data of the SWS is completed as described above, next, the evaluation result calculation processing portion 103 reads out the sleeping depth data stored in the RAM 102 again. Then, based on Equation 1, the evaluation result calculation processing portion 103 calculates the movement appearance ratio n-M.A.R. meeting the set value S of the sleeping depth=R (REM sleep: REM) to store the movement appearance ratio n-M.A.R. in the RAM 102 (S108).

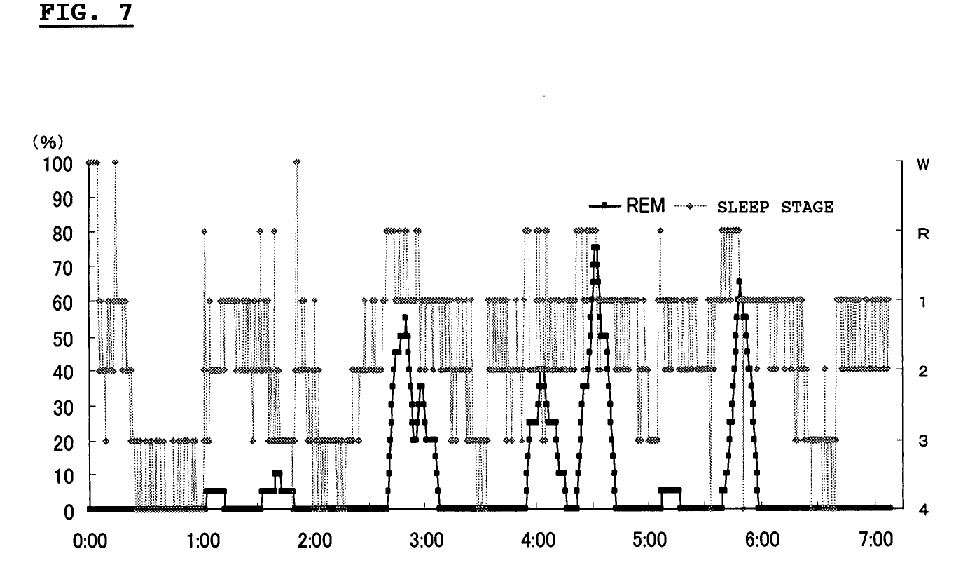

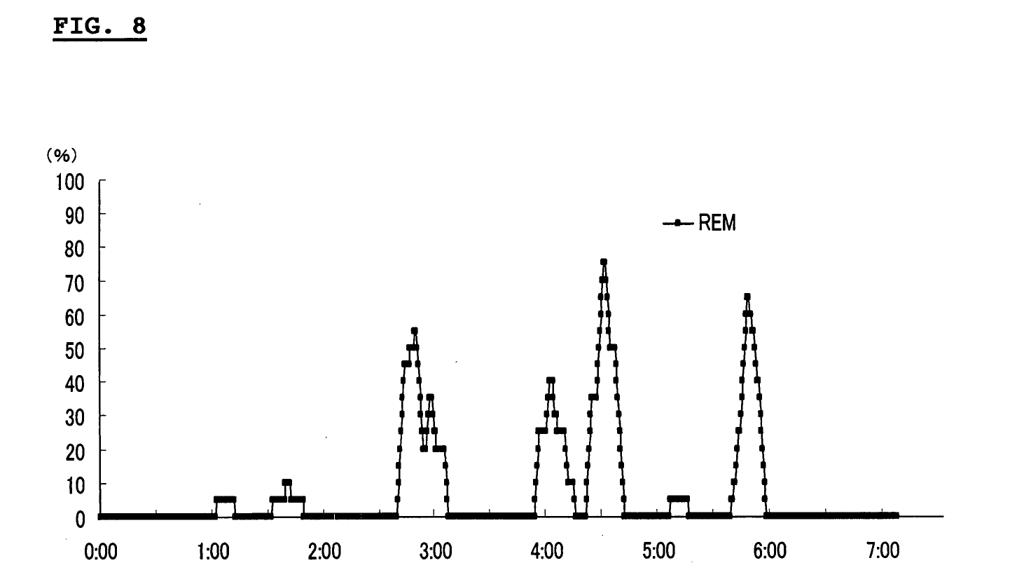

FIGS. 7 and 8 show a calculation example when n=10 minutes and T=0.5 minutes. Here, FIG. 7 shows a graph when the sleeping depth data and the movement appearance ratio data are plotted on a time scale and FIG. 8 shows a graph when only the movement appearance ratio data is plotted on the time scale.

Thereafter, the evaluation result calculation processing portion 104 reads out the stored movement appearance ratio data of the REM from the RAM 102 to process the movement appearance ratio data of the REM in accordance with the evaluation rule for “physical recovery” stored in the evaluation rule storage portion 105. Then, the evaluation result calculation processing portion 104 calculates an evaluation score for the evaluation factor concerned to store the evaluation score in the RAM 102 (S109).

Here, the evaluation rule for “physical recovery” is regulated as follows since the REM sleep is regarded as the sleep of the body (refer to “HANDBOOK OF SLEEP SCIENCE AND SLEEP MEDICINE” issued by ASAKURA PUBLISHING CO. LTD., page 32, 1994, for example).

(1) Setting of Cycle

A period of time from the time at which the movement appearance ratio n-M.A.R of REM rises from 0% to the time at which, after exceeding a predetermined threshold level S1 (e.g., 40%) and then dropping down to 0% again, the movement appearance ratio of the REM rises next time is set as one cycle.

(2) Score for each Cycle

The score is set as 100 when a peak of the movement appearance ratio n-M.A.R. of the REM within a period of time of one cycle reaches 100%. The score decreases as the peak concerned decreases from 100%. Note that the peak of the movement appearance ratio n-M.A.R. of the REM is more difficult to reach 100% as time elapses during sleep. Thus, the period of sleep may be divided into two parts, i.e., the first half and the second half, or may be divided more finely. In this case, a peak value threshold may be gradually decreased from 100% toward the end of the sleep period.

(3) Score for “Physical Recovery”

The total of the scores in the respective cycles is set as a score for “physical recovery”.

In the above-mentioned Step S109, the evaluation result calculation processing portion 104 firstly detects the cycles and the peaks of the movement appearance ratio n-M.A.R. in the respective cycles from the movement appearance ratio n-M.A.R. of the REM. For example, in the example shown in FIG. 8, there are four cycles. Then, the evaluation result calculation processing portion 104 processes the detection results in accordance with the corresponding one of the above-mentioned evaluation rules to calculate an evaluation score for “physical recovery” to store the evaluation score in the RAM 100.

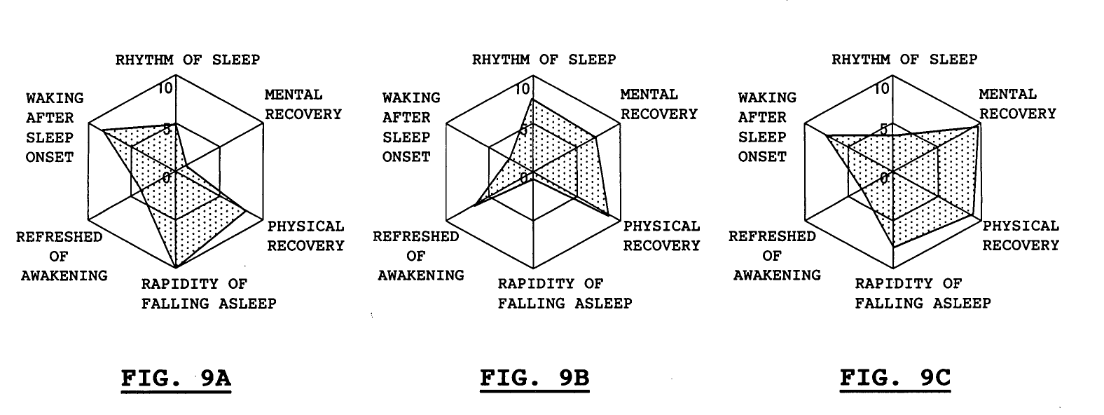

After the processing for calculating the evaluation scores for the evaluation factors such as “waking after sleep onset”, “rhythm of sleep”, “mental recovery”, “rapidity of falling asleep”, “refreshed of awakening” and “physical recovery” is completed in a manner as described above, next, the sleep type classification processing portion 106 reads out the evaluation scores for the evaluation factors stored in the RAM 102 therefrom. Then, the sleep type classification processing portion 106 corrects and normalizes these evaluation scores to output information related to ranks of the evaluation factors (S110). FIGS. 9A to 9C show display examples (three cases) when such rank information is displayed on a display device (monitor). A user can immediately grasp the sleep type of a subject (the user himself/herself when the user is the subject) by referring to such displayed results.

As described above, according to the sleep analyzer of this embodiment, after the sleeping depth data as the qualitative variable is converted into the movement appearance ratio as the quantitative variable, the evaluation factors are analyzed and evaluated using the resultant movement appearance ratio. Thus, the evaluation factors can be quantitatively analyzed and evaluated, and hence the relatively highly reliable sleep analysis results can be provided for a user while simplifying the processing.

It should be noted that the present invention is not intended to be limited to the above-mentioned embodiment, and various changes may be made.

For example, in the above-mentioned embodiment, as objects of execution of the analysis evaluation using the movement appearance ratio, “rhythm of sleep”, “mental recovery”, “rapidity of falling asleep”, “refreshed of awakening” and “physical recovery” are adopted. However, the evaluation factors as the objects in the present invention are not limited to these evaluation factors, and the present invention may be suitably applied to evaluation of evaluation factors other than these evaluation factors.

In addition, in the above-mentioned embodiment, the movement appearance ratio n-M.A.R. of the deep sleep SWS is obtained under the condition having a relation of the set value S of the sleeping depth=2. However, the set value S for calculation of the movement appearance ratio n-M.A.R. of the deep sleep SWS is not limited to these values meeting that condition, and is suitably set in accordance with the experimental and statistical analysis results. In this connection, the set value S may be changed for every evaluation factor. Also, when the level of the sleeping depth is changed from W, R, 1, 2, 3 and 4, the set value S is suitably changed accordingly. Likewise, the movement appearance ratio n-M.A.R. of the REM sleep is also not limited to the foregoing, and is suitably set in accordance with the experimental and statistical analysis results.

It should be noted that, as for the embodiment of the present invention, various changes may be suitably made within the scope of the technical idea of the present invention.

What is claimed is:

1. A sleep analyzer for analyzing a sleep state, comprising:
data generation means for generating data related to an appearance ratio of a sleep stage from data related to a depth of sleep and plotted on a time scale;
storage means for storing therein an evaluation rule corresponding to an evaluation factor; and
evaluation result calculation means for calculating results of evaluation for the evaluation factor by processing the data related to the appearance ratio of the sleep stage and generated by the data generation means in accordance with the evaluation rule stored in the storage means.

2. A sleep analyzer according to claim 1, wherein:
the data generation means calculates an appearance ratio of a sleep stage equal to or higher than a predetermined level for each predetermined time unit;
the storage means stores therein a rule in accordance with which rhythm of sleep is evaluated based on cycle time of a fluctuation cycle of the appearance ratio on the time scale; and
the evaluation result calculation means calculates results of evaluation for rhythm of sleep during the sleep by detecting the cycle time of the fluctuation cycle from the appearance ratio calculated for each predetermined time unit by the data generation means and evaluating the cycle time in accordance with the evaluation rule stored in the storage means.

3. A sleep analyzer according to claim 2, wherein:
the storage means stores therein scores which are set in correspondence to lengths of one cycle time of the fluctuation cycle; and
the evaluation result calculation means obtains the scores for all fluctuation cycles detected with respect to the sleep based on score information stored in the storage means to calculate a rank of the rhythm of sleep from a total score obtained by summing up the scores.

4. A sleep analyzer according to claim 1, wherein:
the data generation means calculates an appearance ratio of a sleep stage equal to or higher than a predetermined level;
the storage means stores therein a rule in accordance with which mental recovery during sleep is evaluated based on the appearance ratio; and
the evaluation result calculation means calculates results of evaluation for mental recovery during the sleep by evaluating the appearance ratio calculated by the data generation means in accordance with the evaluation rule stored in the storage means.

5. A sleep analyzer according to claim 4, wherein:
the data generation means calculates the appearance ratio of the sleep stage equal to or higher than the predetermined level for each predetermined time unit;
the storage means stores a score set in correspondence to a level which an upper limit of the appearance ratio reaches during a period of time of one cycle of the fluctuation cycle of the appearance ratio on the time scale; and
the evaluation result calculation means obtains scores for all fluctuation cycles detected with respect to the sleep based on score information stored in the storage means to calculate a rank of mental recovery from a total score obtained by summing up the scores.

6. A sleep analyzer according to claim 1, wherein:
the data generation means calculates an appearance ratio of a sleep stage at a REM level;
the storage means stores therein a rule in accordance with which physical recovery during sleep is evaluated based on the appearance ratio; and
the evaluation result calculation means calculates results of evaluation for physical recovery during the sleep by evaluating the appearance ratio calculated by the data generation means in accordance with the evaluation rule stored in the storage means.

7. A sleep analyzer according to claim 6, wherein:
the data generation means calculates the appearance ratio of the sleep stage at the REM level;
the storage means stores a score set in correspondence to a level which an upper limit of the appearance ratio reaches during a period of time of one cycle of the fluctuation cycle of the appearance ratio on the time scale; and
the evaluation result calculation means obtains scores for all fluctuation cycles detected with respect to the sleep based on score information stored in the storage means to calculate a rank of physical recovery from a total score obtained by summing up the scores.

8. A sleep analyzer according to claim 1, wherein:
the data generation means calculates an appearance ratio of a sleep stage equal to or higher than a predetermined level for each predetermined time unit;
the storage means stores a rule in accordance with which rapidity of falling asleep is evaluated based on a time period required until the appearance ratio as plotted on the time scale rises for a first time; and
the evaluation result calculation means detects the time period required until the appearance ratio rises for the first time on the time scale from the appearance ratio calculated for each predetermined time unit by the data generation means, and evaluates the time period in accordance with the evaluation rule stored in the storage means to calculate results of evaluation for the rapidity of falling asleep with respect to the sleep.

9. A sleep analyzer according to claim 8, wherein:
the storage means stores a score set in correspondence to the time period required until the appearance ratio rises for the first time; and
the evaluation result calculation means obtains a score for the time period detected with respect to the sleep based on score information stored in the storage means to calculate a rank of the rapidity of falling asleep from the score.

10. A sleep analyzer according to claim 1, wherein:
the data generation means calculates an appearance ratio of a sleep stage equal to or higher than a predetermined level for each predetermined time unit;
the storage means stores a rule in accordance with which a refreshed of awakening is evaluated based on a gradient at which the appearance ratio as plotted on the time scale drops for a last time; and
the evaluation result calculation means detects a gradient at which the appearance ratio drops for the last time on the time scale from the appearance ratio calculated for each predetermined time unit by the data generation means, and evaluates the gradient in accordance with the evaluation rule stored in the storage means to calculate results of evaluation for the refreshed of awakening with respect to the sleep.

11. A sleep analyzer according to claim 10, wherein:
the storage means stores a score set in correspondence to the gradient at which the appearance ratio drops for the last time; and
the evaluation result calculation means obtains a score for the gradient detected with respect to the sleep based on score information stored in the storage means to calculate a rank of the refreshed of awakening from the score.

12. A sleep analyzer for analyzing a sleep state, wherein the sleep analyzer obtains data related to an appearance ratio of a sleep stage from data related to a depth of sleep and plotted on a time scale and carries out sleep analysis based on the obtained data related to the appearance ratio.

13. A program product for giving a sleep analysis function to a computer, comprising:
a data generation step of generating data related to an appearance ratio of a sleep stage from data related to a depth of sleep and plotted on a time scale;
a database prescribing an evaluation rule corresponding to an evaluation factor; and
an evaluation result calculation step of calculating results of evaluation for the evaluation factor by processing the data related to the appearance ratio of the sleep stage and generated in the data generation step in accordance with the evaluation rule.

14. A program product according to claim 13, wherein:
the data generation step comprises calculating an appearance ratio of a sleep stage equal to or higher than a predetermined level for each predetermined time unit;
the database prescribes a rule in accordance with which rhythm of sleep is evaluated based on cycle time of a fluctuation cycle of the appearance ratio on the time scale; and
the evaluation result calculation step comprises detecting the cycle time of the fluctuation cycle from the appearance ratio calculated for each predetermined time unit in the data generation step and evaluating the cycle time in accordance with the evaluation rule prescribed in the database to calculate results of evaluation for rhythm of sleep with respect to the sleep.

15. A program product according to claim 14, wherein:
the database prescribes scores which are set in correspondence to lengths of one cycle time of the fluctuation cycle; and
the evaluation result calculation step comprises obtaining scores for all fluctuation cycles detected with respect to the sleep based on score information prescribed in the database to calculate a rank of the rhythm of sleep from a total score obtained by summing up the scores.

16. A program product according to claim 13, wherein:
the data generation step comprises calculating an appearance ratio of a sleep stage equal to or higher than a predetermined level;
the database prescribes a rule in accordance with which mental recovery during sleep is evaluated based on the appearance ratio; and
the evaluation result calculation step comprises calculating results of evaluation for mental recovery during the sleep by evaluating the appearance ratio calculated by the data generation means in accordance with the evaluation rule prescribed in the database.

17. A program product according to claim 16, wherein:
the data generation step comprises calculating the appearance ratio of the sleep stage equal to or higher than the predetermined level for each predetermined time unit;
the database prescribes a score set in correspondence to a level which an upper limit of the appearance ratio reaches during a period of time of one cycle of the fluctuation cycle of the appearance ratio on the time scale; and
the evaluation result calculation step comprises obtaining scores for all fluctuation cycles detected with respect to the sleep based on score information prescribed in the database to calculate a rank of mental recovery from a total score obtained by summing up the scores.

18. A program product according to claim 13, wherein:
the data generation step comprises calculating an appearance ratio of a sleep stage at a REM level;
the database prescribes a rule in accordance with which physical recovery during sleep is evaluated based on the appearance ratio; and
the evaluation result calculation step comprises calculating results of evaluation for physical recovery during the sleep by evaluating the appearance ratio calculated in the data generation step in accordance with the evaluation rule prescribed in the database.

19. A program product according to claim 18, wherein:
the data generation step comprises calculating the appearance ratio of the sleep stage at the REM level;
the database prescribes a score set in correspondence to a level which an upper limit of the appearance ratio reaches during a period of time of one cycle of the fluctuation cycle of the appearance ratio on the time scale; and
the evaluation result calculation step comprises obtaining scores for all fluctuation cycles detected with respect to the sleep based on score information prescribed in the database to calculate a rank of physical recovery from a total score obtained by summing up the scores.

20. A program product according to claim 13, wherein:
the data generation step comprises calculating an appearance ratio of a sleep stage equal to or higher than a predetermined level for each predetermined time unit;
the database prescribes a rule in accordance with which rapidity of falling asleep is evaluated based on a time period required until the appearance ratio as plotted on the time scale rises for a first time; and
the evaluation result calculation step comprises detecting the time period required until the appearance ratio rises for the first time on the time scale from the appearance ratio calculated for each predetermined time unit in the data generation step, and evaluating the time period in accordance with the evaluation rule prescribed in the database to calculate results of evaluation for the rapidity of falling asleep with respect to the sleep.

21. A program product according to claim 20, wherein:
the database prescribes a score set in correspondence to the time period required until the appearance ratio rises for the first time; and
the evaluation result calculation step comprises obtaining a score for the time period required until the appearance ratio rises for the first time, which is detected with respect to the sleep, based on score information prescribed in the database and calculating a rank of the rapidity of falling asleep from the score.

22. A program product according to claim 13, wherein:
the data generation step comprises calculating an appearance ratio of a sleep stage equal to or higher than a predetermined level for each predetermined time unit;
the database prescribes a rule in accordance with which a refreshed of awakening is evaluated based on a gradient at which the appearance ratio as plotted on the time scale drops for a last time; and
the evaluation result calculation step comprises detecting the gradient at which the appearance ratio drops for the last time on the time scale from the appearance ratio calculated for each predetermined time unit in the data generation step, and evaluating the gradient in accordance with the evaluation rule prescribed in the database to calculate results of evaluation for the refreshed of awakening with respect to the sleep.

23. A program product according to claim 22, wherein:
the database prescribes a score set in correspondence to the gradient at which the appearance ratio drops for the last time; and
the evaluation result calculation step comprises obtaining a score for the gradient detected with respect to the sleep based on score information prescribed in the database to calculate a rank of the refreshed of awakening from the score.

24. A program product for giving a sleep analysis function to a computer, comprising a step of obtaining data related to an appearance ratio of a sleep stage from data related to a depth of sleep and plotted on a time scale and carrying out sleep analysis based on the obtained data related to the appearance ratio.
